(19) United States
(12) Patent Application Publication
(10) Pub. No.: US 2018/0111172 A1
(43) Pub. Date: Apr. 26, 2018

(54) SEALANT DETECTION AND ULTRASONIC CLEANING APPARATUS

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Yanshun HAO, Beijing (CN); Lu PANG, Beijing (CN); Xingang HE, Beijing (CN); Yue WANG, Beijing (CN)

(21) Appl. No.: 15/502,692

(22) PCT Filed: Jul. 21, 2016
(86) PCT No.: PCT/CN2016/090829

§ 371 Date: Feb. 8, 2017

(30) Foreign Application Priority Data
Jan. 5, 2016 (CN) 201620008873.1

(51) Int. Cl. B08B 7/02; B08B 1/02; B08B 5/04; B08B 5/02; G01N 21/84

(52) U.S. Cl. CPC B08B 7/028; B08B 1/02; B08B 5/043; G01N 2021/8427; G01N 21/8422; B08B 2215/006; B08B 5/023

(57) ABSTRACT

A sealant detection and ultrasonic cleaning apparatus (100) is provided. The apparatus (100) comprises: a sealant detection part (1), for detecting whether a sealant on an element to be detected is abnormal; and an ultrasonic cleaning part (2), for carrying out ultrasonic cleaning on the element to be detected, which has been detected by the sealant detection part (1). The sealant detection process and the ultrasonic cleaning process are carried out in one apparatus (100), thereby shortening the process flow and reducing a space occupied by devices.

### TECHNICAL FIELD

Embodiments of the present disclosure relate to a sealant detection and ultrasonic cleaning apparatus.

### BACKGROUND

In recent years, a thin-film transistor liquid crystal display becomes a new-generation display device due to the advantages of high resolution, high color saturation, high response speed, high aperture ratio and the like, and is widely applied to electronic display products, e.g., a mobile phone and the like. An array substrate and a color filter substrate are bonded to each other to form the thin-film transistor liquid crystal display.

Generally, after being coated with a sealant, the color filter substrate firstly enters a sealant detection device, then enters an ultrasonic cleaning device, and finally is subjected to a bonding process, so that the color filter substrate and the array substrate are firmly bonded together. In this way, the process flow is complex, and capacity is relatively low; and moreover, more devices are required for production and the purchase and maintenance cost of the devices is huge.

### SUMMARY

According to embodiments of the disclosure, a sealant detection and ultrasonic cleaning apparatus is provided. The apparatus comprises: a sealant detection part, for detecting whether a sealant on an element to be detected is abnormal; and an ultrasonic cleaning part, for carrying out ultrasonic cleaning on the element to be detected, which has been detected by the sealant detection part.

For example, the sealant detection part includes an outlet and an inlet, and the ultrasonic cleaning part is arranged on a side of the outlet of the sealant detection part.

For example, the apparatus further comprises: a position detection part, for detecting a position of the element to be detected; and a control part, for controlling the sealant detection part to detect whether the sealant on the element to be detected is abnormal in the case that the element to be detected is positioned in the sealant detection part and controlling the ultrasonic cleaning part to carry out cleaning on the element to be detected in the case that the element to be detected is positioned in the ultrasonic cleaning part.

For example, the control part is further configured for controlling the element to be detected to enter and exit from the sealant detection part and the ultrasonic cleaning part.

For example, the control part controls the element to be detected to be removed from an inlet of the sealant detection part and sends out prompt information in the case that the sealant detection part detects that the sealant on the element to be detected is abnormal.

For example, the control part controls the element to be detected to be removed from an outlet of the sealant detection part and enter the ultrasonic cleaning part through an inlet of the ultrasonic cleaning part in the case that the sealant detection part detects that the sealant on the element to be detected is normal. For example, after the ultrasonic cleaning part carries out ultrasonic cleaning on the element to be detected, the control part controls the element to be detected to be removed from the inlet of the ultrasonic cleaning part, enter the sealant detection part through the outlet of the sealant detection part and be removed from an inlet of the sealant detection part; or after the ultrasonic cleaning part carries out ultrasonic cleaning on the element to be detected, the control part controls the element to be detected to be removed from an outlet of the ultrasonic cleaning part.

For example, the apparatus further comprises: a rack, on which the sealant detection part and the ultrasonic cleaning part are arranged; and a mobile platform, arranged on the rack and configured for bearing the element to be detected to enter and exit from the sealant detection part and the ultrasonic cleaning part.

For example, the apparatus further comprises: a sucker, arranged on the mobile platform and configured for fixing the element to be detected.

For example, the sealant detection part includes a light source, a collimation laser, a beam splitter and an image controller; the light source is configured for irradiating a surface of the element to be detected, which is uncoated with the sealant; the collimation laser emits collimation laser light, and the collimation laser light is irradiated to the sealant on the element to be detected after passing through the beam splitter; and the image controller is configured for receiving the collimation laser reflected by the sealant and judging whether the sealant is abnormal according to the received collimation laser.

For example, the ultrasonic cleaning part includes: a pressure chamber, a vacuum chamber and an ultrasonic generator; gas in the pressure chamber is jetted onto the element to be detected by the ultrasonic generator provided at an opening of the pressure chamber so as to enable particles on the surface of the element to be detected to be diffused; and the vacuum chamber is configured for sucking the diffused particles into the vacuum chamber from an opening of the vacuum chamber.

For example, the element to be detected is an opposed substrate coated with the sealant and/or an array substrate coated with the sealant before a bonding process of bonding the opposed substrate and the array substrate.

### BRIEF DESCRIPTION OF THE DRAWINGS

In order to more clearly illustrate the technical solution of the embodiments of the disclosure, the drawings of the embodiments will be briefly described in the following. It is obvious that the described drawings are only related to some embodiments of the disclosure, but not intended to limit the present disclosure.

FIG. 1 is a schematic block view illustrating a sealant detection and ultrasonic cleaning apparatus provided by embodiments of the present disclosure;

FIG. 2 is a structural schematic view illustrating the sealant detection and ultrasonic cleaning apparatus provided by the embodiments of the present disclosure;

FIG. 3 is a schematic view illustrating a sealant detection part of the sealant detection and ultrasonic cleaning apparatus provided by the embodiments of the present disclosure; and

FIG. 4 shows a schematic view illustrating an ultrasonic cleaning part of the sealant detection and ultrasonic cleaning apparatus provided by the embodiments of the present disclosure.

### DETAILED DESCRIPTION

In order to make objects, technical details and advantages of the embodiments of the disclosure apparent, the technical solutions of the embodiment will be described in a clearly and fully understandable way in connection with the drawings. It is obvious that the described embodiments are just a part but not all of the embodiments of the disclosure. Based on the described embodiments of the disclosure, those skilled in the art can obtain all other embodiment(s), without any inventive work, which should be within the scope of the disclosure.

It should be noted that in the case of no conflict, embodiments of the present disclosure and features in the embodiments can be combined mutually.

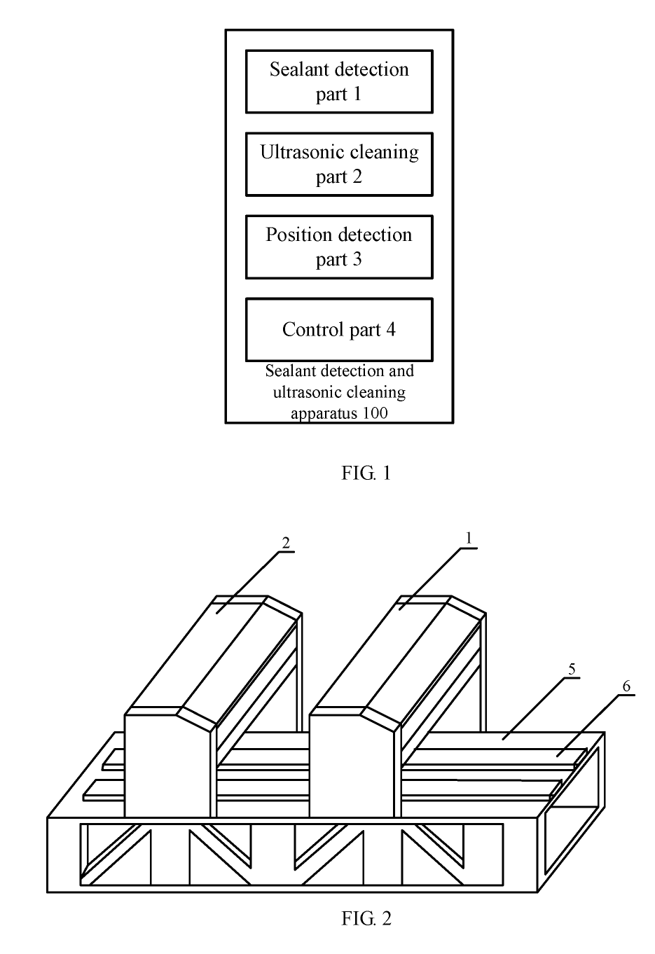

FIG. 1 is a schematic block view illustrating a sealant detection and ultrasonic cleaning apparatus provided by the embodiments of the present disclosure. With reference to FIG. 1, the sealant detection and ultrasonic cleaning apparatus 100 includes a sealant detection part and an ultrasonic cleaning part. The sealant detection part 1 is configured for detecting whether a sealant on an element to be detected is abnormal; and the ultrasonic cleaning part 2 is configured for carrying out ultrasonic cleaning on the element to be detected, which has been detected by the sealant detection part.

For example, the element to be detected is an opposed substrate coated with the sealant and/or an array substrate coated with the sealant before a bonding process. For example, the opposed substrate is a color filter substrate.

The element to be detected, for example, is fed into the sealant detection and ultrasonic cleaning apparatus provided by the embodiments of the present disclosure by a manipulator. The element to be detected firstly enters the sealant detection part to be subjected to a sealant detection process, and then enters the ultrasonic cleaning part to be subjected to an ultrasonic cleaning process. After two processes are completed, the element to be detected is taken out by the manipulator so as to carry out a next process.

The sealant detection and ultrasonic cleaning apparatus provided by the embodiments of the present disclosure includes the ultrasonic cleaning part and the sealant detection part. The element to be detected, which is detected by the sealant detection part and is qualified in sealant, directly enters the ultrasonic cleaning part from the sealant detection part, so that the sealant detection process and the ultrasonic cleaning process are carried out in one apparatus, thereby shortening the process flow and reducing a space occupied by devices.

For example, the sealant detection part in the sealant detection and ultrasonic cleaning apparatus provided by the embodiments of the present disclosure includes an outlet and an inlet, and the ultrasonic cleaning part is arranged on a side of the outlet of the sealant detection part.

It should be noted that: an outlet and an inlet of the sealant detection and ultrasonic cleaning apparatus are the same opening or different openings. For example, in the case that the outlet and the inlet of the sealant detection and ultrasonic cleaning apparatus are the same opening, the inlet of the sealant detection part is used as the outlet and the inlet of the sealant detection and ultrasonic cleaning apparatus. For example, in the case that the outlet and the inlet of the sealant detection and ultrasonic cleaning apparatus are different openings, the inlet of the sealant detection part is used as the inlet of the sealant detection and ultrasonic cleaning apparatus, and the outlet of the ultrasonic cleaning part is used as the outlet of the sealant detection and ultrasonic cleaning apparatus.

According to the embodiments of the present disclosure, a position relationship of the sealant detection part and the ultrasonic cleaning part may be reasonably set according to a sequence of the process flow so as to guarantee the element to be detected to travel along the most convenient and rapidest path in the processes of carrying out sealant detection and ultrasonic cleaning, thereby shortening used time of the process flow and improving production efficiency.

For example, the sealant detection and ultrasonic cleaning apparatus provided by the embodiments of the present disclosure further includes: a position detection part 3, for detecting a position of the element to be detected; and a control part 4, for controlling the sealant detection part 1 to detect whether the sealant on the element to be detected is abnormal in the case that the element to be detected is positioned in the sealant detection part 1, and controlling the ultrasonic cleaning part 2 to carry out cleaning on the element to be detected in the case that the element to be detected is positioned in the ultrasonic cleaning part 2.

For example, the position detection part 3 includes a sensor or a camera.

It should be noted that: the position detection part 3 for example includes a first sub detection part arranged in the sealant detection part 1 and a second sub detection part arranged in the ultrasonic cleaning part 2; or the position detection part 3 for example is a detection part capable of moving along with the element to be detected. The position detection part 3 transmits detected position information of the element to be detected to the control part, and the control part controls the sealant detection part to start to detect the element to be detected and controls the ultrasonic cleaning part to start to carry out cleaning on the element to be detected according to the position information.

Further, in the case that preheating or parameter regulation needs to be carried out before the sealant detection part or the ultrasonic cleaning part works, according to the position of the element to be detected, which is detected by the position detection part, or the process in which the element to be detected is positioned, the control part controls the part which the element to be detected is to enter to proceed to a ready state or a parameter regulation state so as to save time of the process flow. For example, after the control part receives the information that the position detection part detects that the element to be detected is subjected to the sealant detection process in the sealant detection part and before the element to be detected enters the ultrasonic cleaning part, the control part controls the ultrasonic cleaning part to carry out regulation of related parameters and carry out preheating so as to shorten time of the process flow of carrying out sealant detection and ultrasonic cleaning on the element to be detected.

The sealant detection and ultrasonic cleaning apparatus provided by the embodiments of the present disclosure adopts the position detection part to detect the position of the element to be detected, so that the control part correctly controls the operation of the sealant detection part and the ultrasonic cleaning part.

For example, according to the embodiments of the present disclosure, the control part of the sealant detection and ultrasonic cleaning apparatus is further configured for controlling the element to be detected to enter and exit from the sealant detection part and the ultrasonic cleaning part.

It should be noted that: for the process that the control part controls the element to be detected to enter and exit from the sealant detection part and the ultrasonic cleaning part, the control part for example controls the element to be detected to firstly enter the sealant detection part to carry out sealant detection and then enter the ultrasonic cleaning part to carry out ultrasonic cleaning according to the process flow, or the control part for example controls the element to be detected to enter the sealant detection part for detection without entering the ultrasonic cleaning part. Namely, the control part can control the movement path of the element to be detected as required.

According to the sealant detection and ultrasonic cleaning apparatus provided by the embodiments of the disclosure, the control part controls movement of the element to be detected as required, so that smoothness of the technical process is guaranteed.

For example, the control part of the sealant detection and ultrasonic cleaning apparatus provided by the embodiments of the present disclosure controls the element to be detected to be removed from the inlet of the sealant detection part and sends out a prompt information in the case that the sealant detection part detects that the sealant on the element to be detected is abnormal.

The sealant detection and ultrasonic cleaning apparatus provided by the embodiments of the present disclosure does not carry out ultrasonic cleaning on the element to be detected in the case that the sealant on the element to be detected is abnormal, so that time is saved.

For example, in the sealant detection and ultrasonic cleaning apparatus provided by the embodiments of the disclosure, the control part controls the element to be detected to be removed from the outlet of the sealant detection part and enter the ultrasonic cleaning part through an inlet of the ultrasonic cleaning part in the case that the sealant detection part detects that the sealant on the element to be detected is normal; after the ultrasonic cleaning part carries out ultrasonic cleaning on the element to be detected, the control part controls the element to be detected to be removed from the inlet of the ultrasonic cleaning part, enter the sealant detection part through the outlet of the sealant detection part and be removed from the inlet of the sealant detection part; or after the ultrasonic cleaning part carries out ultrasonic cleaning on the element to be detected, the control part controls the element to be detected to be removed from an outlet of the ultrasonic cleaning part.

The sealant detection and ultrasonic cleaning apparatus provided by the embodiments of the disclosure continues to carry out ultrasonic cleaning on the element to be detected in the case that the sealant on the element to be detected is normal.

For example, the sealant detection and ultrasonic cleaning apparatus provided by the embodiments of the present disclosure further includes: a rack, on which the sealant detection part and the ultrasonic cleaning part are arranged; and a mobile platform, arranged on the rack and configured for bearing the element to be detected to enter and exit from the sealant detection part and the ultrasonic cleaning part.

FIG. 2 is a structural schematic view illustrating the sealant detection and ultrasonic cleaning apparatus provided by the embodiments of the present disclosure. With reference to FIG. 2, the sealant detection part 1 and the ultrasonic cleaning part 2 are arranged on the rack 5, and the mobile platform 6 is also arranged on the rack.

In the case that the element to be detected is subjected to sealant detection and ultrasonic cleaning, the element to be detected is placed on the mobile platform 6 of the rack 5, the mobile platform 6 drives the element to be detected to enter the sealant detection part 1 and the ultrasonic cleaning part 2; and after sealant detection and ultrasonic cleaning are carried out, the mobile platform 6 drives the element to be detected to be removed from the sealant detection and ultrasonic cleaning apparatus.

According to the sealant detection and ultrasonic cleaning apparatus provided by the embodiments of the present disclosure, the sealant detection part 1 and the ultrasonic cleaning part 2 are arranged on the rack 5, so that stability of the entire apparatus is guaranteed. By using the mobile platform 6, the element to be detected stably moves on the rack 5.

For example, the sealant detection and ultrasonic cleaning apparatus provided by the embodiments of the present disclosure further includes: a sucker, arranged on the mobile platform 6 and configured for fixing the element to be detected.

According to the sealant detection and ultrasonic cleaning apparatus provided by the embodiments of the present disclosure, the sucker for fixing the element to be detected is arranged on the mobile platform 6, so that the element to be detected in the sealant detection and ultrasonic cleaning process is fixed on the mobile platform 6, and accuracy of position detection is guaranteed.

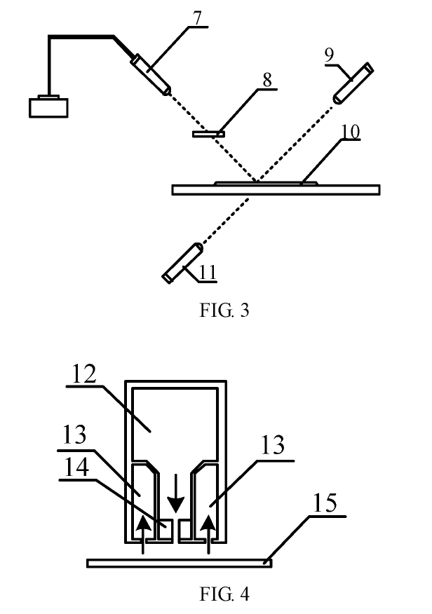

For example, the sealant detection part in the sealant detection and ultrasonic cleaning apparatus provided by the embodiments of the present disclosure is shown in FIG. 3.

As shown in FIG. 3, for example, the sealant detection part includes a collimation laser 7, a beam splitter 8, an image controller 9 and a light source 11. The light source 11 is configured for irradiating a surface of the element to be detected, which is uncoated with the sealant, and providing illumination for detection of the sealant; the collimation laser 7 emits collimation laser light, and the collimation laser light is irradiated to the sealant on the element to be detected after passing through the beam splitter 8; and the image controller 9 is configured for receiving the collimation laser reflected by the sealant and judging whether the sealant is abnormal according to the received collimation laser light.

The collimation laser light emitted by the collimation laser 7 is irradiated to the sealant 10 on the element to be detected after passing through the beam splitter 8, and is received by the image controller 9 after being reflected by the sealant 10. The image controller 9 judges whether the sealant on the substrate is abnormal by analyzing the received collimation laser.

The sealant detection part in the sealant detection and ultrasonic cleaning apparatus provided by the embodiments of the present disclosure detects whether the sealant has a case that the sealant is broken or a width of the sealant does not accord with requirements.

For example, the ultrasonic cleaning part in the sealant detection and ultrasonic cleaning apparatus provided by the embodiments of the present disclosure is as shown in FIG. 4.

As shown in FIG. 4, for example, the ultrasonic cleaning part includes: a pressure chamber 12, a vacuum chamber 13 and an ultrasonic generator 14. Gas in the pressure chamber 12 is jetted onto the element to be detected, e.g., a substrate 15, by the ultrasonic generator 14 provided at an opening of the pressure chamber 12 so as to enable particles on the surface of the element to be detected to be diffused; and the vacuum chamber 13 is configured for sucking the diffused particles into the vacuum chamber 13 from an opening of the vacuum chamber 13.

The ultrasonic cleaning part in the sealant detection and ultrasonic cleaning apparatus provided by the embodiments of the present disclosure cleans the element to be detected by the pressure chamber 12, the vacuum chamber 13 and the ultrasonic generator 14.

The sealant detection and ultrasonic cleaning apparatus provided by the embodiments of the present disclosure includes the ultrasonic cleaning part and the sealant detection part. The element to be detected, which is detected by the sealant detection part and is qualified in sealant, directly enters the ultrasonic cleaning part from the sealant detection part, so that not only the sealant detection process but also the ultrasonic cleaning process are carried out in one apparatus, thereby shortening the process flow and reducing the space occupied by devices.

In the embodiments of the present disclosure, words such as “first” and “second” are only used for description, but should not be understood as denotation or suggestion on relative importance. The phrase “a plurality of” indicates that there are two or more than two, unless otherwise defined.

The foregoing embodiments merely are exemplary embodiments of the disclosure, and not intended to define the scope of the disclosure, and the scope of the disclosure is determined by the appended claims.

The present application claims priority of the Chinese Patent Application No. 201620008873.1 filed on Jan. 5, 2016, the disclosure of which are incorporated herein by its reference in its entirety as part of the present application.

1. A sealant detection and ultrasonic cleaning apparatus, comprising:
a sealant detection part, for detecting whether a sealant on an element to be detected is abnormal; and
an ultrasonic cleaning part, for carrying out ultrasonic cleaning on the element to be detected, which has been detected by the sealant detection part.

2. The sealant detection and ultrasonic cleaning apparatus according to claim 1, wherein the sealant detection part includes an outlet and an inlet, and
the ultrasonic cleaning part is arranged on a side of the outlet of the sealant detection part.

3. The sealant detection and ultrasonic cleaning apparatus according to claim 1, further comprising:
a position detection part, for detecting a position of the element to be detected; and
a control part, for controlling the sealant detection part to detect whether the sealant on the element to be detected is abnormal in the case that the element to be detected is positioned in the sealant detection part and controlling the ultrasonic cleaning part to carry out cleaning on the element to be detected in the case that the element to be detected is positioned in the ultrasonic cleaning part.

4. The sealant detection and ultrasonic cleaning apparatus according to claim 3, wherein the control part is further configured for controlling the element to be detected to enter and exit from the sealant detection part and the ultrasonic cleaning part.

5. The sealant detection and ultrasonic cleaning apparatus according to claim 4, wherein
the control part controls the element to be detected to be removed from an inlet of the sealant detection part and sends out prompt information in the case that the sealant detection part detects that the sealant on the element to be detected is abnormal.

6. The sealant detection and ultrasonic cleaning apparatus according to claim 4, wherein
the control part controls the element to be detected to be removed from an outlet of the sealant detection part and enter the ultrasonic cleaning part through an inlet of the ultrasonic cleaning part in the case that the sealant detection part detects that the sealant on the element to be detected is normal,
after the ultrasonic cleaning part carries out ultrasonic cleaning on the element to be detected, the control part controls the element to be detected to be removed from the inlet of the ultrasonic cleaning part, enter the sealant detection part through the outlet of the sealant detection part and be removed from an inlet of the sealant detection part; or after the ultrasonic cleaning part carries out ultrasonic cleaning on the element to be detected, the control part controls the element to be detected to be removed from an outlet of the ultrasonic cleaning part.

7. The sealant detection and ultrasonic cleaning apparatus according to claim 1, further comprising:
a rack, on which the sealant detection part and the ultrasonic cleaning part are arranged; and
a mobile platform, arranged on the rack and configured for bearing the element to be detected to enter and exit from the sealant detection part and the ultrasonic cleaning part.

8. The sealant detection and ultrasonic cleaning apparatus according to claim 7, further comprising:
a sucker, arranged on the mobile platform and configured for fixing the element to be detected.

9. The sealant detection and ultrasonic cleaning apparatus according to claim 1, wherein
the sealant detection part includes a light source, a collimation laser, a beam splitter and an image controller;
the light source is configured for irradiating a surface of the element to be detected, which is uncoated with the sealant;
the collimation laser emits collimation laser light, and the collimation laser light is irradiated to the sealant on the element to be detected after passing through the beam splitter; and
the image controller is configured for receiving the collimation laser reflected by the sealant and judging whether the sealant is abnormal according to the received collimation laser.

10. The sealant detection and ultrasonic cleaning apparatus according to claim 1, wherein
the ultrasonic cleaning part includes: a pressure chamber, a vacuum chamber and an ultrasonic generator;
gas in the pressure chamber is jetted onto the element to be detected by the ultrasonic generator provided at an opening of the pressure chamber so as to enable particles on the surface of the element to be detected to be diffused; and
the vacuum chamber is configured for sucking the diffused particles into the vacuum chamber from an opening of the vacuum chamber.

11. The sealant detection and ultrasonic cleaning apparatus according to claim 1, wherein
the element to be detected is an opposed substrate coated with the sealant and/or an array substrate coated with the sealant before a bonding process of bonding the opposed substrate and the array substrate.

12. The sealant detection and ultrasonic cleaning apparatus according to claim 2, wherein
the sealant detection part includes a light source, a collimation laser, a beam splitter and an image controller;
the light source is configured for irradiating a surface of the element to be detected, which is uncoated with the sealant;
the collimation laser emits collimation laser light, and the collimation laser light is irradiated to the sealant on the element to be detected after passing through the beam splitter; and
the image controller is configured for receiving the collimation laser reflected by the sealant and judging whether the sealant is abnormal according to the received collimation laser.

13. The sealant detection and ultrasonic cleaning apparatus according to claim 2, wherein
the ultrasonic cleaning part includes: a pressure chamber, a vacuum chamber and an ultrasonic generator;
gas in the pressure chamber is jetted onto the element to be detected by the ultrasonic generator provided at an opening of the pressure chamber so as to enable particles on the surface of the element to be detected to be diffused; and
the vacuum chamber is configured for sucking the diffused particles into the vacuum chamber from an opening of the vacuum chamber.

14. The sealant detection and ultrasonic cleaning apparatus according to claim 3, wherein
the sealant detection part includes a light source, a collimation laser, a beam splitter and an image controller;
the light source is configured for irradiating a surface of the element to be detected, which is uncoated with the sealant;
the collimation laser emits collimation laser light, and the collimation laser light is irradiated to the sealant on the element to be detected after passing through the beam splitter; and
the image controller is configured for receiving the collimation laser reflected by the sealant and judging whether the sealant is abnormal according to the received collimation laser.

15. The sealant detection and ultrasonic cleaning apparatus according to claim 3, wherein
the ultrasonic cleaning part includes: a pressure chamber, a vacuum chamber and an ultrasonic generator;
gas in the pressure chamber is jetted onto the element to be detected by the ultrasonic generator provided at an opening of the pressure chamber so as to enable particles on the surface of the element to be detected to be diffused; and
the vacuum chamber is configured for sucking the diffused particles into the vacuum chamber from an opening of the vacuum chamber.
